(19) United States
(12) Patent Application Publication
(10) Pub. No.: US 2012/0271746 A1
(43) Pub. Date: Oct. 25, 2012

(54) AUTOMATE METHOD AND SYSTEM FOR CREATING TRADEABLE HEDGE FUND INDICIES

(75) Inventors: Richard L. Sandor, Chicago, IL (US); Murali Kanakasabai, Chicago, IL (US); Nathan J. Clark, Evanston, IL (US); Rafael L. Marques, Chicago, IL (US)

(73) Assignee: Environmental Financial Products, LLC., Chicago, IL (US)

(21) Appl. No.: 13/091,902

(22) Filed: Apr. 21, 2011

(51) Int. Cl. G06Q 40/00

(52) U.S. Cl. 705/37

(57) ABSTRACT

An automated method and system for creating tradable hedge fund indices. One or more sets of hedge fund trading information is obtained on a application on a target device. The application creates one or more sets of tradable indices representing hedge fund performance from the received one or more sets of hedge fund trading information. The application displays the created one or more sets of tradable hedge fund indices in one more windows on a multi-windowed graphical user interface (GUI) The one or more sets of tradable hedge fund indices include, but are not limited to, equal weighted, asset weighted and/or aggregated hybrid tradable indices.

### FIELD OF THE INVENTION

This invention relates to hedge funds. More specifically, it relates to an automated method and system for creating tradable hedge fund indices.

### BACKGROUND OF THE INVENTION

A “hedge fund” is an alternative investment that is designed to protect investment portfolios from market uncertainty, while generating positive returns in both up and down markets. A hedge fund is typically a private investment fund which may invest in a diverse range of assets and may employ a variety of investment strategies to maintain a hedged portfolio intended to protect the fund's investors from downturns in the market while maximizing returns on market upswings.

Hedge funds are distinct from mutual funds, individual retirement and investment accounts, and other types of traditional investment portfolios in a number of ways. As a class, hedge funds undertake a wider range of investment and trading activities than traditional long-only investment funds, and invest in a broader range of assets, including equities, bonds and commodities. By taking a long position on a particular asset a hedge fund manager is asserting that this position is likely to increase in value. When the hedge manager takes a short position in another asset they would be asserting that the asset is likely to decrease in value.

The US Securities and Exchange Commission have deemed hedge funds inappropriate for the average investor. US securities laws restrict investors in hedge funds to “accredited investors.” Accredited investors are defined as any natural person who had individual income in excess of $200,000 in each of the two most recent years or joint income with that person's spouse in excess of $300,000 in each of those years and has a reasonable expectation of reaching the same income level in the current year. This definition includes approximately 8% of US households. Therefore, 92% of households in the US are precluded by law from participating in hedge fund investments.

Most hedge fund investment strategies aim to secure positive return on investment regardless of overall market performance. Hedge fund managers seek to deliver active management called “Alpha.” Alpha is a risk-adjusted measure of the so-called “excess return” on an investment. It is a common measure of assessing an active hedge fund manager's performance as it is the return in excess of a benchmark index

Investors in hedge funds typically pay a management fee that goes toward the operational costs of the fund, and a performance fee when the fund's net asset value is higher than that of the previous year. The net asset value of a hedge fund can be billions of dollars, due to investments from large institutional investors including pension funds, university endowments and foundations.

Hedge funds employ many different trading strategies, which are classified in many different ways. No standard system is used. A hedge fund will typically commit itself to a particular strategy, particular investment types and leverage limits via statements in its offering documentation, thereby giving investors some indication of the nature of the particular fund.

In general, hedge fund indices provide performance benchmarks based on a large and representative sample of hedge funds. For example, hedge fund indices focus on capturing the average return and risk characteristics of hedge funds viewed as an asset class, rather than attempting to outperform the asset class by choosing better performing hedge funds for the hedge fund index.

A hedge fund index is typically published on a pre-determined (e.g., monthly) basis and typically represent the weighted average performance of hedge funds included in the hedge fund index. The performance can be calculated and published for the overall index, as well as for various subsets of the overall index as defined, for example, by an investment strategy, geographical location, assets under management, etc.

There are many indices that track the hedge fund industry. In traditional equity investment, indices play a central and unambiguous role. They are widely accepted as representative, and products such as commodity futures and Exchange Traded Funds (ETFs) provide investable access to hedge funds in most developed markets.

However, hedge funds are also typically illiquid, heterogeneous and ephemeral, which makes it hard to construct a satisfactory index. Non-investable indices are representative, but, due to various biases, their quoted returns may not be available in practice. Investable indices achieve liquidity at the expense of limited representativeness. Clone indices seek to replicate some statistical properties of hedge funds but are not directly based on them.

Comparisons of hedge fund indexes have limitations because hedge fund indices have volatility and other material characteristics that may differ from a particular hedge fund. For example, a hedge fund may typically hold substantially fewer securities than are contained in a hedge fund index. Hedge fund indices also may contain securities or types of securities that are not comparable to those traded by a hedge fund. Therefore, a hedge fund's performance may differ substantially from the performance of a hedge fund index. Because of these differences, many hedge fund indexes currently known in the art cannot not be relied upon as an accurate measure of calculation or comparison for hedge funds. However, it is desirable to create hedge fund indices that can be publically or privately traded.

There have been other attempts to solve some of the problems associated with hedge funds indices. For example, U.S. Published Patent Application No. 20110022539 published by Joenk teaches “The system and method for managing a financial portfolio relative to market stability includes determining a first allocation of assets in the portfolio and a level of equity exposure, the portfolio including a plurality of funds; monitoring a quantitative risk indicator for market signals, determining whether the quantitative risk indicator meets a predetermined risk threshold value and if the risk indicator meets the risk threshold value, adjusting the level of equity exposure by selling a first position on a first set of options associated with a first fund and purchasing a second position on a second set of options associated with a second fund.”

U.S. Published Patent Application No. 20100241593, published by Umlauf and U.S. Pat. No. 7,739,178 that issued to Umlauf teaches “A system comprises a memory operable to store a compound index that is based at least in part on a plurality of component indices. The plurality of component indices comprise an international developed markets equity index, a U.S. large-cap equity index, and a U.S. small-cap equity index. The compound index is further based at least in part on a plurality of weights, wherein each weight is associated with a respective one of the plurality of component indices. The system further comprises a processor communicatively coupled to the memory and operable to update the plurality of weights according to a regression analysis. The regression analysis is based at least in part on a respective set of returns associated with each of the plurality of component indices and with a hedge fund index. The plurality of weights are updated such that the compound index emulates the hedge fund index. The processor is further operable to determine a current compound index value based at least in part on the plurality of component indices and on the updated plurality of weights. The processor is further operable to transmit the current compound index value to one or more clients.”

U.S. Published Patent Application No. 20090138409 published by Galanis teaches “An online investment system includes an entry module programmed to receive information about an investor, retrieve the investor's credit score, and value one or more assets pledged by the investor to fund the investor's investment. The system also includes an investment options module programmed to offer the investor a plurality of investment options based on the investor's credit score, at least one of the investment options including a term deposit tied to performance of a hedge fund index.”

U.S. Pat. No. 7,818,241, that issued to Ho, et al. teaches “This invention relates to hedge fund indexing in general and methods and systems for constructing and maintaining investable hedge fund indices in particular.

U.S. Pat. No. 7,756,768, that issued to Ho, et al. teaches “This invention relates to hedge fund indexing in general and methods and systems for constructing and maintaining investable hedge fund indices in particular.

However, none of these attempts solve all of the problems associated with creating and trading hedge fund indices. Thus, it is desirable to solve some more of the problems associated with problems associated with creating and treating hedge fund indices.

### SUMMARY OF THE INVENTION

In accordance with preferred embodiments of the present invention, some of the problems associated measuring hedge fund performance are overcome. An automated method and system for creating tradable hedge fund indices is provided.

One or more sets of hedge fund trading information is obtained on an application on a target device. The application creates one or more sets of tradable indices representing hedge fund performance from the received one or more sets of hedge fund trading information. The application displays the created one or more sets of tradable hedge fund indices in one more windows on a multi-windowed graphical user interface (GUI) The application provides secure execution of one or more electronic trades via the created one or more sets of tradable hedge fund indices displayed on the GUI on one or more electronic trading exchanges or other trading entities. The one or more sets of tradable hedge fund indices including, but not limited to, equal weighted, asset weighted and/or aggregated hybrid tradable indices.

The foregoing and other features and advantages of preferred embodiments of the present invention is more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary tradable hedge fund index creation system;

FIG. 2 is a block diagram illustrating an exemplary tradable hedge fund index creation display system;

FIG. 3 is a flow diagram illustrating a method for creating tradable hedge fund indices;

FIG. 4 is a flow diagram illustrating a method for creating equal weighted tradable hedge fund indices;

FIG. 5 is a flow diagram illustrating a method for creating asset weighted tradable hedge fund indices;

FIG. 6 is a flow diagram illustrating a method for creating aggregated hybrid tradable hedge fund indices; and

FIG. 7 is a block diagram illustrating graphical display of tradable hedge fund indices on a graphical user interface.

### DETAILED DESCRIPTION OF THE INVENTION

### Exemplary Hedge Fund Evaluation System

A “hedge fund” is typically a private investment fund which may invest in a diverse range of assets and may employ a variety of investment strategies to maintain a hedged portfolio intended to protect the fund's investors from downturns in the market while maximizing returns on market upswings. Hedge funds are distinct other types of traditional investment portfolios. As a class, hedge funds typically undertake a wider range of investment and trading activities than traditional long-only investment funds (e.g., mutual funds, individual retirement accounts, investment accounts, etc.) and invest in a broader range of assets, including equities, bonds and/or commodities, etc.

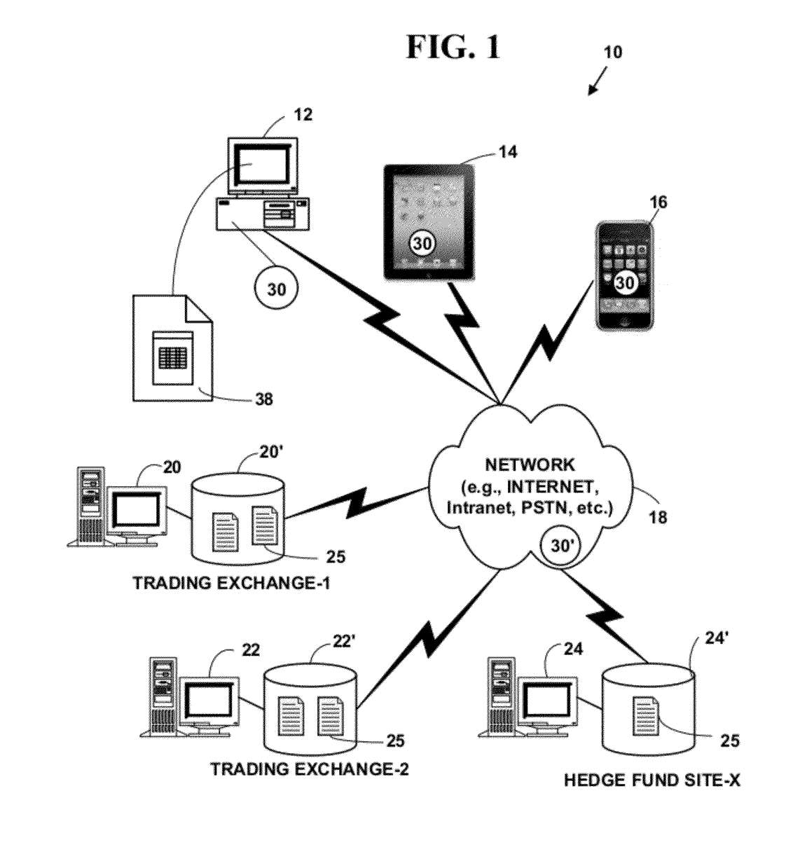

FIG. 1 is a block diagram illustrating an exemplary tradable hedge fund index creation system 10. The exemplary tradable hedge fund index creation system 10 includes, but is not limited to, one or more target network devices 12, 14, 16 (only three of which are illustrated) each with one or more processors. However, the present invention is not limited to these target network devices and more, fewer or others types of target electronic devices can also be used.

The target network devices 12, 14, 16 are in communications with a communications network 18. The communications includes, but is not limited to, communications over a wire connected to the target network devices 12, 14, 16 with a wired interface, wireless communications with a wireless interface, and other types of communications using one or more communications and/or networking protocols.

In one embodiment, the target network devices 12, 14, 16 includes a wireless ultra-band (e.g., WiMAX, etc.) or baseband wireless transceiver for communicating with a wireless communications network.

As is known in the art, “ultra-band” or ultra-wideband (UWB) is a radio frequency (RF) technology that can be used at very low energy levels for short-range high-bandwidth communications by using a large portion of the radio spectrum.

As is known in the art, a “baseband” transceiver is a transceiver in which information is carried in digital form in one or more channels on a transmission medium. A baseband includes any frequency band on which information is superimposed, whether or not a frequency band is multiplexed and on which digital information can be sent on sub-bands.

The system 10 includes one or more server network devices 20, 22, 24 (only three of which are illustrated) each with one or more processors and one or more associated databases 20′, 22′, 24′. The plural server network devices 20, 22, 24 are in communications with the one or more target devices 12, 14, 16 via the communications network 18. The plural server network devices 20, 22, 24, include, but are not limited to, World Wide Web servers, Internet servers, file servers, trading exchange servers, hedge fund web-site servers, other types of electronic information servers, and other types of server network devices (e.g., edge servers, firewalls, routers, gateways, etc.).

The plural server network devices 20, 22, 24 include, but are not limited to, servers used for electronic trading exchanges, servers for providing electronic information for electronic trading brokers, servers for electronic trading information providers, hedge fund information providers 25, etc.

The server network devices 20, 22, 24 are also in communications with a communications network 18. The communications includes, but is not limited to, communications over a wire connected to the server network devices with a wired interface, wireless communications with a wireless interface, and other types of communications using one or more communications and/or networking protocols.

The one or more target network devices 12, 14, 16, include, but are not limited to, personal digital/data assistants (PDA), laptop computers, mobile computers, Internet appliances, two-way pagers, mobile phones, non-mobile phones, or other similar desktop, mobile or hand-held electronic devices and/or client terminals in communications with one or more servers, or with. Other or equivalent devices can also be used to practice the invention.

In one specific exemplary embodiment, the one or more target network devices 12, 14, 16 also include smart phones 14 such as the iPhone by Apple, Inc., Blackberry Storm and other Blackberry models by Research In Motion, Inc. (RIM), Droid by Motorola, Inc. HTC, Inc. other types of smart phones, other types of mobile and non-mobile phones, etc. However, the present invention is not limited to such devices, and more, fewer or other devices can be used to practice the invention.

A “smart phone” is a mobile phone that offers more advanced computing ability and connectivity than a contemporary basic feature phone. Smart phones and feature phones may be thought of as handheld computers integrated with a mobile telephone, but while most feature phones are able to run applications based on platforms such as Java ME, a smart phone usually allows the user to install and run more advanced applications. Smart phones and/or tablet computers run complete operating system software providing a platform for application developers assessable trough a specialized Application Programming Interface (API).

The operating systems include the iPhone OS, Android, Windows, etc. iPhone OS is a proprietary operating system for the Apple iPhone. Andriod is an open source operating system platform backed by Google, along with major hardware and software developers (such as Intel, HTC, ARM, Motorola and Samsung, etc.), that form the Open Handset Alliance. The Apple iPad 14 is illustrated in FIG. 1.

The one or more target network devices 12, 14, 16 also include tablet computers 16 such as the iPad, by Apple, Inc., the HP Tablet, by Hewlett Packard, Inc., the Playbook, by RIM, Inc., the Tablet, by Sony, Inc.

The network devices include an application 26. In one embodiment, the application 26 is a software application. However, the present invention is not limited to this embodiment and the application 26 includes firmware, hardware or a combination thereof. In one embodiment, the application 26 exists only on the target network devices 12, 14, 16. In another embodiment, application 26′ exists only on server network devices. In another embodiment, a portion of the application 26 exists on the target network devices 12, 14, 16 and another portion 26′ exists one or more server network devices. However, the present invention is not limited to these embodiments and other embodiments and other combinations can also be used to practice the invention.

In one embodiment of the invention, the application 26 is an application for a smart phone. A smart network device application includes interactions with an operating system on a smart phone. In another embodiment, the application 26 is an application for the tablet computer. The interactions for the application 26 are typically completed through an Application Programming Interface (API).

The communications network 18 includes, but is not limited to, the Internet, an intranet, a wired Local Area Network (LAN), a wireless LAN (WiLAN), a Wide Area Network (WAN), a Metropolitan Area Network (MAN), a Personal Wireless Network, a Public Switched Telephone Network (PSTN) and other types of communications networks 18.

In one embodiment, the plural server network devices 20, 22, 24 include a connection to plural network interface cards (NICs) in a backplane connected to a communications bus. The NIC cards provide gigabit/second (1×109 bits/second) communications speed of electronic trading information. This allows “scaling out” for electronic trading. The NICs are connected to the plural server network devices 20, 22, 24 and the communications network 18. However, the present invention is not limited to the NICs described and other types of NICs in other configurations and connections with or without a buse can also be used to practice the invention.

In one embodiment, devices and interfaces including the NICs include “4G” components. As is known in the art “4G” refers to the fourth generation of wireless communications standards. It is a successor to 3G and 2G standards. The nomenclature of the generations generally refers to a change in the fundamental nature of the service. The first was the move from analogue (1G) to digital (2G) transmission. This was followed by multi-media support, spread spectrum transmission and at least 200 kbits/second (3G).

The 4G NICs include IP packet-switched NICs, wired and wireless ultra-broadband (i.e., gigabit speed) access NICs, Worldwide Interoperability for Microwave Access (WiMAX) NICs and multi-carrier transmission NICs. However, the present invention is not limited to this embodiment and 1G, 2G and 3G and/or any combination thereof, with or with 4G NICs can be used to practice the invention.

In one embodiment, the wireless interfaces for the network devices include but are not limited to, an IEEE 802.11a, 802.11b, 802.11g, 802.11n, 802.15.4 (ZigBee), “Wireless Fidelity” (Wi-Fi), “Worldwide Interoperability for Microwave Access” (WiMAX), ETSI High Performance Radio Metropolitan Area Network (HIPERMAN) or “RF Home” wireless interfaces. In another embodiment of the present invention, the wireless sensor device may include an integral or separate Bluetooth and/or infra data association (IrDA) module for wireless Bluetooth or wireless infrared communications. (not illustrated). However, the present invention is not limited to such an embodiment and other 802.11xx and other types of wireless interfaces can also be used.

As is known in the art, an 802.11b is a short-range wireless network standard. The IEEE 802.11b standard defines wireless interfaces that provide up to 11 Mbps wireless data transmission to and from wireless devices over short ranges. 802.11a is an extension of the 802.11b and can deliver speeds up to 54M bps. 802.11g deliver speeds on par with 802.11a. However, other 802.11XX interfaces can also be used and the present invention is not limited to the 802.11 protocols defined. The IEEE 802.11a, 802.11b and 802.11g standards are incorporated herein by reference.

As is known in the art, Wi-Fi is a type of 802.11xx interface, whether 802.11b, 802.11a, dual-band, etc. Wi-Fi devices include an RF interfaces such as 2.4 GHz for 802.11b or 802.11g and 5 GHz for 802.11a. More information on Wi-Fi can be found at the URL “www.weca.net.”

As is known in the art, 802.15.4 (Zigbee) is low data rate network standard used for mesh network devices such as sensors, interactive toys, smart badges, remote controls, and home automation. The 802.15.4 standard provides data rates of 250 kbps, 40 kbps, and 20 kbps., two addressing modes; 16-bit short and 64-bit IEEE addressing, support for critical latency devices, such as joysticks, Carrier Sense Multiple Access/Collision Avoidance, (CSMA-CA) channel access, automatic network establishment by a coordinator, fully handshake protocol for transfer reliability, power management to ensure low power consumption for multi-month to multi-year battery usage and up to 16 channels in the 2.4 GHz Industrial, Scientific and Medical (ISM) band (Worldwide), 10 channels in the 915 MHz (US) and one channel in the 868 MHz band (Europe). The IEEE 802.15.4-2003 standard is incorporated herein by reference. More information on 802.15.4 and ZigBee can be found at the URL “www.ieee802.org” and “www.zigbee.org” respectively.

As is known in the art, WiMAX is an industry trade organization formed by leading communications component and equipment companies to promote and certify compatibility and interoperability of broadband wireless access equipment that conforms to the IEEE 802.16XX and ETSI HIPERMAN. HIPERMAN is the European standard for metropolitan area networks (MAN).

The IEEE The 802.16a and 802.16g standards are wireless MAN technology standard that provides a wireless alternative to cable, DSL and T1/E1 for last mile broadband access. It is also used as complimentary technology to connect IEEE 802.11XX (hot spots to the Internet.

The IEEE 802.16a standard for 2-11 GHz is a wireless MAN technology that provides broadband wireless connectivity to fixed, portable and nomadic devices. It provides up to 50-kilometers of service area range, allows users to get broadband connectivity without needing direct line of sight with the base station, and provides total data rates of up to 280 Mbps per base station, which is enough bandwidth to simultaneously support hundreds of businesses with T1/E1-type connectivity and thousands of homes with DSL-type connectivity with a single base station. The IEEE 802.16g provides up to 100 Mbps.

The IEEE 802.16e standard is an extension to the approved IEEE 802.16/16a/16g standard. The purpose of 802.16e is to add limited mobility to the current standard which is designed for fixed operation.

The ESTI HIPERMAN standard is an interoperable broadband fixed wireless access standard for systems operating at radio frequencies between 2 GHz and 11 GHz.

The IEEE 802.16a, 802.16e and 802.16g standards are incorporated herein by reference. More information on WiMAX can be found at the URL “www.wimaxforum.org.” WiMAX can be used to provide a WLP.

The ETSI HIPERMAN standards TR 101 031, TR 101 475, TR 101 493-1 through TR 101 493-3, TR 101 761-1 through TR 101 761-4, TR 101 762, TR 101 763-1 through TR 101 763-3 and TR 101 957 are incorporated herein by reference. More information on ETSI standards can be found at the URL “www.etsi.org.” ETSI HIPERMAN can be used to provide a WLP.

In one specific exemplary embodiment, the communications network 18 includes a Microsoft®.NET framework. The .NET Framework and .NET Compact Framework offer a rich library of object classes that allow developers to create scalable applications both implicitly and explicitly. The .NET Framework also offers object classes that access, for example, Microsoft® Message Queuing (MSMQ) messaging services. The .NET Framework also allows building of desktop and Web applications and applications for handheld devices using the .NET Compact Framework or for cell mobile devices using the Mobile Internet Toolkit. However, the present invention is not limited to this embodiment and other scaling out frameworks can also be used to practice the invention.

The communications network 18 may include one or more gateways, routers, bridges, switches. As is known in the art, a gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another. A switch is a device that filters and forwards packets between network segments. Switches typically operate at the data link layer and sometimes the network layer therefore support virtually any packet protocol.

The communications network 18 includes, but is not limited to, data networks using the Transmission Control Protocol (TCP), User Datagram Protocol (UDP), Internet Protocol (IP) and other data protocols.

As is know in the art, TCP provides a connection-oriented, end-to-end reliable protocol designed to fit into a layered hierarchy of protocols which support multi-network applications. TCP provides for reliable inter-process communication between pairs of processes in network devices attached to distinct but interconnected networks. For more information on TCP see Internet Engineering Task Force (ITEF) Request For Comments (RFC)-793, the contents of which are incorporated herein by reference.

As is known in the art, UDP provides a connectionless mode of communications with datagrams in an interconnected set of computer networks. UDP provides a transaction oriented datagram protocol, where delivery and duplicate packet protection are not guaranteed. For more information on UDP see IETF RFC-768, the contents of which incorporated herein by reference.

As is known in the art, IP is an addressing protocol designed to route traffic within a network or between networks. IP is described in IETF Request For Comments (RFC)-791, the contents of which are incorporated herein by reference. However, more fewer or other protocols can also be used on the communications network 18 and the present invention is not limited to TCP/UDP/IP.

An operating environment for the network devices of the exemplary tradable hedge fund index creation system 10 include a processing system with one or more high speed Central Processing Unit(s) (“CPU”), processors and one or more memories. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It is appreciated that acts and symbolically represented operations or instructions include the manipulation of electrical information by the CPU or processor. An electrical system represents data bits which cause a resulting transformation or reduction of the electrical information, and the maintenance of data bits at memory locations in a memory system to thereby reconfigure or otherwise alter the CPU's or processor's operation, as well as other processing of information. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”), flash memory, etc.) mass storage system readable by the CPU. The computer readable medium includes cooperating or interconnected computer readable medium, which exist exclusively on the processing system or can be distributed among multiple interconnected processing systems that may be local or remote to the processing system.

### Security and Encryption

Network devices and wired and/or wireless interfaces of the present invention may include security and encryption for secure communications over the communications network 18 using one or more security and/or encryption methods.

Wireless Encryption Protocol (WEP) (also called “Wired Equivalent Privacy) is a security protocol for WiLANs defined in the IEEE 802.11b standard. WEP is cryptographic privacy algorithm, based on the Rivest Cipher 4 (RC4) encryption engine, used to provide confidentiality for 802.11b wireless data.

As is known in the art, RC4 is cipher designed by RSA Data Security, Inc. of Bedford, Mass., which can accept encryption keys of arbitrary length, and is essentially a pseudo random number generator with an output of the generator being XORed with a data stream to produce encrypted data.

One problem with WEP is that it is used at the two lowest layers of the OSI model, the physical layer and the data link layer, therefore, it does not offer end-to-end security. One another problem with WEP is that its encryption keys are static rather than dynamic. To update WEP encryption keys, an individual has to manually update a WEP key. WEP also typically uses 40-bit static keys for encryption and thus provides “weak encryption,” making a WEP device a target of hackers.

The IEEE 802.11 Working Group is working on a security upgrade for the 802.11 standard called “802.11i.” This supplemental draft standard is intended to improve WiLAN security. It describes the encrypted transmission of data between systems 802.11X WiLANs. It also defines new encryption key protocols including the Temporal Key Integrity Protocol (TKIP). The IEEE 802.11i draft standard, version 4, completed Jun. 6, 2003, is incorporated herein by reference.

The 802.11i is based on 802.1x port-based authentication for user and device authentication. The 802.11i standard includes two main developments: Wi-Fi Protected Access (WPA) and Robust Security Network (RSN).

WPA uses the same RC4 underlying encryption algorithm as WEP. However, WPA uses TKIP to improve security of keys used with WEP. WPA keys are derived and rotated more often than WEP keys and thus provide additional security. WPA also adds a message-integrity-check function to prevent packet forgeries.

RSN uses dynamic negotiation of authentication and selectable encryption algorithms between wireless access points and wireless devices. The authentication schemes proposed in the draft standard include Extensible Authentication Protocol (EAP). One proposed encryption algorithm is an Advanced Encryption Standard (AES) encryption algorithm.

Dynamic negotiation of authentication and encryption algorithms lets RSN evolve with the state of the art in security, adding algorithms to address new threats and continuing to provide the security necessary to protect information that WiLANs carry.

The NIST developed a new encryption standard, the Advanced Encryption Standard (AES) to keep government information secure. AES is intended to be a stronger, more efficient successor to Triple Data Encryption Standard (3DES). More information on NIST AES can be found at the URL “www.nist.gov/aes.”

As is known in the art, DES is a popular symmetric-key encryption method developed in 1975 and standardized by ANSI in 1981 as ANSI X.3.92, the contents of which are incorporated herein by reference. As is known in the art, 3DES is the encrypt-decrypt-encrypt (EDE) mode of the DES cipher algorithm. 3DES is defined in the ANSI standard, ANSI X9.52-1998, the contents of which are incorporated herein by reference. DES modes of operation are used in conjunction with the NIST Federal Information Processing Standard (FIPS) for data encryption (FIPS 46-3, October 1999), the contents of which are incorporated herein by reference.

The NIST approved a FIPS for the AES, FIPS-197. This standard specified “Rijndael” encryption as a FIPS-approved symmetric encryption algorithm that may be used by U.S. Government organizations (and others) to protect sensitive information. The NIST FIPS-197 standard (AES FIPS PUB 197, November 2001) is incorporated herein by reference.

The NIST approved a FIPS for U.S. Federal Government requirements for information technology products for sensitive but unclassified (SBU) communications. The NIST FIPS Security Requirements for Cryptographic Modules (FIPS PUB 140-2, May 2001) is incorporated herein by reference.

As is known in the art, RSA is a public key encryption system which can be used both for encrypting messages and making digital signatures. The letters RSA stand for the names of the inventors: Rivest, Shamir and Adleman. For more information on RSA, see U.S. Pat. No. 4,405,829, now expired, incorporated herein by reference.

As is known in the art, “hashing” is the transformation of a string of characters into a usually shorter fixed-length value or key that represents the original string. Hashing is used to index and retrieve items in a database because it is faster to find the item using the shorter hashed key than to find it using the original value. It is also used in many encryption algorithms.

Secure Hash Algorithm (SHA), is used for computing a secure condensed representation of a data message or a data file. When a message of any length <2⁶⁴ bits is input, the SHA-1 produces a 160-bit output called a “message digest.” The message digest can then be input to other security techniques such as encryption, a Digital Signature Algorithm (DSA) and others which generates or verifies a security mechanism for the message. SHA-512 outputs a 512-bit message digest. The Secure Hash Standard, FIPS PUB 180-1, Apr. 17, 1995, is incorporated herein by reference.

Message Digest-5 (MD-5) takes as input a message of arbitrary length and produces as output a 128-bit “message digest” of the input. The MD5 algorithm is intended for digital signature applications, where a large file must be “compressed” in a secure manner before being encrypted with a private (secret) key under a public-key cryptosystem such as RSA. The IETF RFC-1321, entitled “The MD5 Message-Digest Algorithm” is incorporated here by reference.

As is known in the art, providing a way to check the integrity of information transmitted over or stored in an unreliable medium such as a wireless network is a prime necessity in the world of open computing and communications. Mechanisms that provide such integrity check based on a secret key are called “message authentication codes” (MAC). Typically, message authentication codes are used between two parties that share a secret key in order to validate information transmitted between these parties.

Keyed Hashing for Message Authentication Codes (HMAC), is a mechanism for message authentication using cryptographic hash functions. HMAC is used with any iterative cryptographic hash function, e.g., MD5, SHA-1, SHA-512, etc. in combination with a secret shared key. The cryptographic strength of HMAC depends on the properties of the underlying hash function. The IETF RFC-2101, entitled “HMAC: Keyed-Hashing for Message Authentication” is incorporated here by reference.

As is known in the art, an Electronic Code Book (ECB) is a mode of operation for a “block cipher,” with the characteristic that each possible block of plaintext has a defined corresponding cipher text value and vice versa. In other words, the same plaintext value will always result in the same cipher text value. Electronic Code Book is used when a volume of plaintext is separated into several blocks of data, each of which is then encrypted independently of other blocks. The Electronic Code Book has the ability to support a separate encryption key for each block type.

As is known in the art, Diffie and Hellman (DH) describe several different group methods for two parties to agree upon a shared secret in such a way that the secret will be unavailable to eavesdroppers. This secret is then converted into various types of cryptographic keys. A large number of the variants of the DH method exist including ANSI X9.42. The IETF RFC-2631, entitled “Diffie-Hellman Key Agreement Method” is incorporated here by reference.

However, the present invention is not limited to the security or encryption techniques described and other security or encryption techniques can also be used.

As is known in the art, the HyperText Transport Protocol (HTTP) Secure (HTTPs), is a standard for encrypted communications on the World Wide Web. HTTPs is actually just HTTP over a Secure Sockets Layer (SSL). For more information on HTTP, see IETF RFC-2616 incorporated herein by reference.

As is known in the art, the SSL protocol is a protocol layer which may be placed between a reliable connection-oriented network layer protocol (e.g. TCP/IP) and the application protocol layer (e.g. HTTP). SSL provides for secure communication between a source and destination by allowing mutual authentication, the use of digital signatures for integrity, and encryption for privacy.

The SSL protocol is designed to support a range of choices for specific security methods used for cryptography, message digests, and digital signatures. The security method are negotiated between the source and destination at the start of establishing a protocol session. The SSL 2.0 protocol specification, by Kipp E. B. Hickman, 1995 is incorporated herein by reference. More information on SSL is available at the URL See “netscape.com/eng/security/SSL_{—}2.html.”

As is known in the art, Transport Layer Security (TLS) provides communications privacy over the Internet. The protocol allows client/server applications to communicate over a transport layer (e.g., TCP) in a way that is designed to prevent eavesdropping, tampering, or message forgery. For more information on TLS see IETF RFC-2246, incorporated herein by reference.

In one embodiment, the security functionality includes Cisco Compatible EXtensions (CCX). CCX includes security specifications for makers of 802.11xx wireless LAN chips for ensuring compliance with Cisco's proprietary wireless security LAN protocols. As is known in the art, Cisco Systems, Inc. of San Jose, Calif. is supplier of networking hardware and software, including router and security products.

### Exemplary Tradable Hedge Fund Index Creation Display System

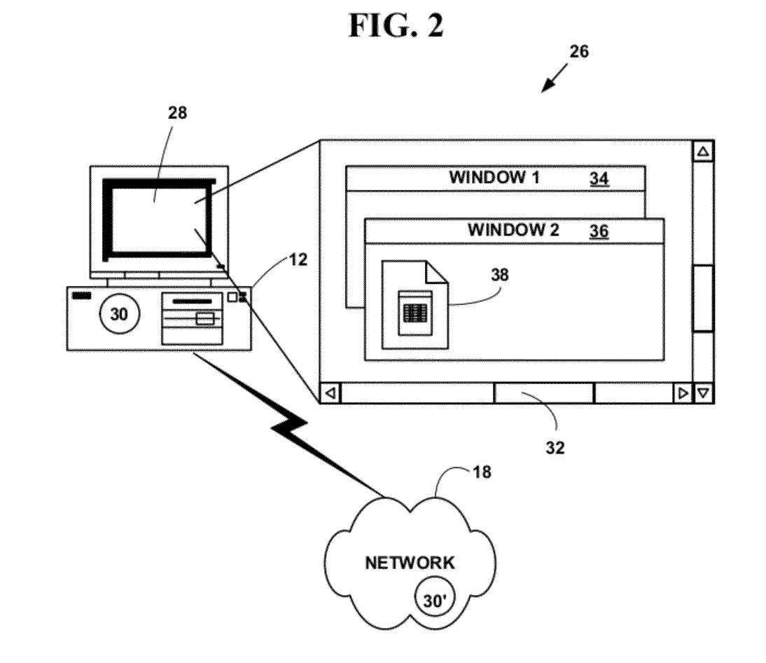

FIG. 2 is a block diagram illustrating an exemplary tradable hedge fund index creation display system 28. The exemplary display system 28 includes, but is not limited to a target network device (e.g., 12) with a display component 30. The target network device 12 includes the application 26 that presents a graphical user interface (GUI) 32 and other functionality on the display component 30. The GUI 32 presents a multi-windowed 34, 36 interface to a user.

### Exemplary Method for Creating Tradable Hedge Fund Indices

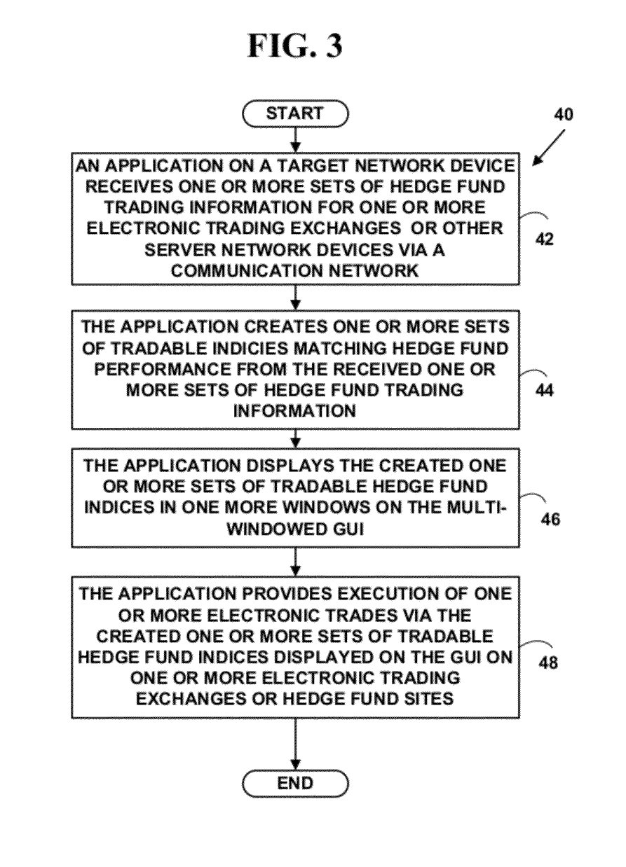

FIG. 3 is a flow diagram illustrating a Method 40 for creating tradable hedge fund indices. At Step 42, one or more sets of hedge fund trading information is obtained on a application on a target device with one or more processors from one or more electronic trading exchanges including one or more server network devices each with one or more processors and/or from one or more other server network devices each with one or more processors (e.g., hedge fund web-site servers, etc.) The one or more sets of hedge fund trading information are received on the application via one or more application program interfaces (API) and/or fixed and/or dynamic connections from the one or more electronic trading exchanges. At Step 44, the application automatically creates one or more sets of tradable hedge fund indices representing hedge fund performance from the received one or more sets of hedge fund trading information. At Step 46, the application displays the created one or more sets of tradable hedge fund indices in one more windows on a multi-windowed graphical user interface (GUI) 32. At Step 48, the application provides secure execution of one or more electronic trades via the created one or more sets of tradable hedge fund indices displayed on the GUI on one or more electronic trading exchanges and/or hedge fund sites and/or private trading sites.

Method 40 is illustrated with a specific exemplary embodiment. However, the present invention is not limited to this specific exemplary embodiment and other embodiments can also be used to practice the invention.

In such a specific exemplary embodiment At Step 42, one or more sets of hedge fund trading information 25 is obtained on a application 26 on a target device 12, 14, 16 with one or more processors from one or more electronic trading exchanges 20, 22 including one or more server network devices each with one or more processors and/or one or more other server network devices 24 (e.g., hedge fund servers, etc.) each with one or more processors such as hedge fund web-site servers 24, etc.

The one or more sets of hedge fund trading information are received on the application 26 via one or more application program interfaces (API) and/or fixed and/or dynamic connections from the one or more electronic trading exchanges 20, 22.

As is known in the art, an API is set of routines used by an application program to direct the performance of actions by a target device. In the present invention, the application 26 is interfaced to one or more API.

In another embodiment, the application 26 is directly interfaced to a fixed or dynamic connection to one or more electronic trading exchanges 20, 22 without using an API. The application 26 provides flexibility to the user to configure the display of electronic information on the GUI 32.

In one embodiment, the received one or more sets of hedge fund trading information are stored in RAM and/or a non-transitory computer readable medium (e.g., hard drive, flash memory, etc.) and/or a database and/or in a spreadsheet and/or in a data file associated with application 26 on the target network device 12, 14, 16. However, the present invention is not limited to such an embodiment and other embodiments, may be used to practice the invention.

At Step 44, the application 26 creates one or more sets of tradable indices 38 representing hedge fund performance from the received one or more sets of hedge fund trading information.

The one or more sets of tradable indices 38 representing hedge fund performance include tradable product comprise a financial product for which trading orders can be accepted, trade orders executed and trade order execution results reported in real-time to/from a designated trading exchange and/or hedge fund sites and/or private trading sites.

In one embodiment, the one or more sets of tradable indices 38 representing hedge fund performance comprise a financial product regulated by the security (e.g., Security and Exchange Commission (SEC), etc.) and/or futures (Commodity Futures Trading Commission (CTFC), etc.) laws of the United States and/or similar security and/or commodity future laws of other countries and traded on an electronic trading exchange 20, 22.

In another embodiment, the one or more sets of tradable indices 38 representing hedge fund performance comprise an unregulated and/or proprietary and/or private financial product offered by a private entity.

In one embodiment the one or more sets of tradable indices 38 are traded on a private and/or proprietary trading exchange and/or hedge fund web-site 24.

In another embodiment, the one or more sets of tradable indices 38 are traded on a public stock exchange and/or public commodities exchange, including but not limited to: NASDAQ/AMEX, New York Stock Exchange (NYSE), Tokyo Stock Exchange, Shanghai Stock Exchange, Shenzhen Stock Exchange, European Energy Exchange, Shanghai Environment Energy Exchange (SEEE), Chicago Board Options Exchange (CBOE), Chicago Mercantile Exchange (CME), Chicago Board of Trade (CBOT), The London International Financial Futures and Options Exchange (LIFFE), Dalian Commodity Exchange (DCE), Zhengzhou Commodity Exchange (ZCE), etc.

In one embodiment, the one or more electronic trading exchanges comprise one or more trading exchanges comprise one or more unregulated and/or proprietary trading exchanges provide by private parties.

However, the present invention is not limited to such embodiments and other types of tradable indices 38 and/or public and/or private and/or proprietary trading exchanges and/or hedge fund web-sites can be used to practice the invention.

At Step 46, the application 26 displays the created one or more sets of tradable hedge fund indices 38 in one more windows 34, 36 on the multi-windowed graphical user interface (GUI) 32.

At Step 48, the application 26 provides secure execution of one or more electronic trades via the created one or more sets of tradable hedge fund indices 38 displayed on the GUI 32 on one or more electronic trading exchanges 20, 22 and/or hedge fund sites 24 and/or private trading sites.

In one embodiment at Step 48, the created one or more sets of tradable hedge fund indices 38 offers electronic traders such as hedge fund managers and other electronic traders an opportunity to execute electronic trades via the application 26 and GUI 32 to maximize portfolio returns and quickly exploit market activities across bull and bear scenarios within hedge fund asset classes (e.g., credit, commodity futures, foreign exchange (FX), fixed income, emerging market, energy, equity, ETF, etc.).

### Creating Families of Tradable Hedge Fund Indices

The methods and system described herein include a family of tradable hedge fund indices that seeks to match the performance of the hedge fund industry. Among the style indices described under the various index categories, the use of total inflows and net new inflows as a performance parameter as well as potential weighting factors in index construction is unique and offers many advantages from a trading standpoint.

This is different from the traditional approach using total Assets under Management (AUM) as the criteria in some index construction. The widespread use of AUM in hedge fund index construction is based on the belief that funds with larger assets in the selected universe of funds should be better represented in the overall index. In other words, the index thus constructed is expected to be representative depiction of where the value resides in universe of funds. This logic is similar to the use of market capitalization in several equity indices methodologies or trading volume in commodity indices.

One limitation that could arise by use of AUM as the weighting parameter is that, while it does represent the overall value of asset distribution in the selected hedge fund universe, it may not dynamically represent changes in market preference or strategy shifts that the industry may be experiencing. This is due to the fact that several funds may have lock-in periods or other provisions that restrict the movement of assets flows over time. In other words, the AUM may be a good stationary indicator of value in the short term and over longer periods of time reflect the shifts in market preferences.

The use of Net new Inflows and Total Inflows of assets are used as one method of measuring performance and weighting in index construction. These methods depict actual new inflows of capital and net inflows of capital into the funds and thus dynamically capturing market valuation of the firms. Investors make decisions to invest in a particular fund based on numerous variables including fund strategy, manager experience & styles, geographic focus, past performance etc. The total new inflows (& net inflows) to a fund are thus actual revealed preferences of the market valuation of the expected performance of the funds. The index thus constructed is able to capture short term shifts in market preferences which are particularly useful from a trading standpoint.

In one embodiment of the invention, developed hedge fund index series are categorized into three broad categories as defined by a weighting methodology used to create them. Each category has several different hedge fund style indices defined by selection of individual pre-determined hedge fund components used for that hedge fund index construction from the hedge fund universe.

Table 1 illustrates exemplary broad categories as defined by an exemplary weighting methodology. However, the present invention is not limited to the categories listed in Table 1, and more, fewer and/or other weighting methodologies can be used to practice the invention.

TABLE 1

| | |
|---|---|
| 1. | Equal Weighted Hedge Fund Indices |

| | |
|---|---|
| a. | Top Assets Under Management (AUM) Index: Index of Top |
| | Hedge Funds as defined by their Asset Under management |
| b. | Top Total Inflow Index: Index of Top Hedge Funds as defined |
| | by their Total Asset Inflows |
| c. | Top net new Inflow Index: Index of Top Hedge Funds as |
| | defined by their Net New Asset Inflows. |

| | |
|---|---|
| 2. | Asset Weighted Hedge Fund Indices |

| | |
|---|---|
| a. | Top Assets Under Management (AUM) Index: Index of Top |
| | Hedge Funds as defined by their Asset Under management |
| b. | Top Total Inflow Index: Index of Top Hedge Funds as defined |
| | by their Total Asset Inflows |
| c. | Top net new Inflow Index: Index of Top Hedge Funds as |
| | defined by their Net New Asset Inflows. |

| | |
|---|---|
| 3. | Aggregated Hybrid Hedge Fund Indices |

| | |
|---|---|
| a. | Hybrid Index of Equally weighted indices: This comprises |
| | of a combination of the equally weighted index category. |
| b. | Hybrid Index of AUM weighted indices: This comprises of a |
| | combination of the AUM weighted index category. |
| c. | Hybrid Index weighted X-indices: This comprises of a |
| | combination of any number of weighted index categories. |

### Category 1: Equal Weighted Tradable Hedge Fund Indices

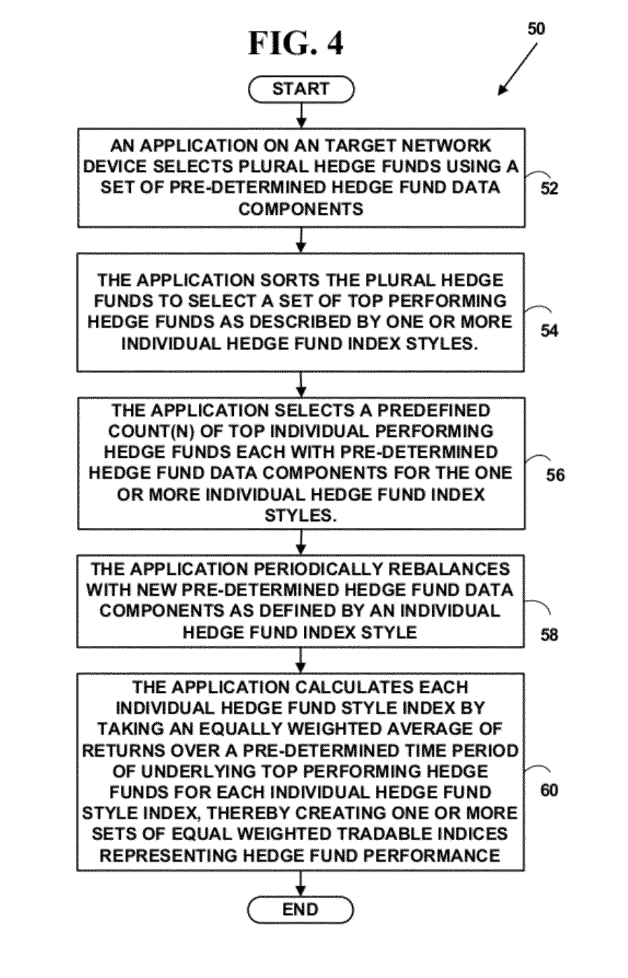

FIG. 4 is a flow diagram illustrating a Method 50 for creating equal weighted tradable hedge fund indices. At Step 52, an application on a target network device selects plural hedge funds using a set of pre-determined hedge fund data components. At Step 54, the application sorts the plural hedge funds to select a set of top performing hedge funds as described by one or more individual hedge fund index styles. At Step 56, the application selects a predefined count(N) of top individual performing hedge funds each with pre-determined hedge fund data components for the one or more individual hedge fund index styles. At Step 58, the application periodically rebalances with new pre-determined hedge fund data components as defined by an individual hedge fund index style. At Step 60, the application calculates each individual hedge fund style index by taking an equally weighted average of hedge fund returns over a pre-determined time period of underlying top performing hedge funds for each individual hedge fund style index, thereby creating one or more sets of equal weighted tradable indices representing hedge fund performance.

Method 50 is illustrated with a specific exemplary embodiment. However, the present invention is not limited to this specific exemplary embodiment and other embodiments can also be used to practice the invention.

In one exemplar embodiment, the pre-determined time period is a quarter of a year (i.e., three months). However, the present invention is not limited to this embodiment and other pre-determined time periods can be used to practice the invention.

In such an exemplary embodiment at Step 52, the application 26 on the target network device 12, 14, 16, selects plural hedge funds using a set of pre-determined hedge fund data components.

In one embodiment the set of pre-determined hedge fund data components include: a hedge fund name, a dollar value (e.g., United States dollars, Euros, Yen, Pounds, etc.) of quarterly hedge fund assets under management (AUM), a percentage of quarterly hedge fund returns, a dollar value of quarterly hedge fund assets inflows and a dollar value of quarterly hedge fund asset outflows.

In another embodiment, the set of pre-determined hedge fund data components include: a hedge fund name, a monetary value of quarterly hedge fund assets under management (AUM), a percentage of quarterly hedge fund returns, a monetary value of quarterly hedge fund assets inflows and a monetary value of quarterly hedge fund asset outflows.

The monetary value may be a monetary value of an actual currency or a synthetic currency (i.e., a currency that can be traded but does not actually exist). For example, a synthetic currency may include a combination of United States Dollars and Japanese Yen. Such a synthetic currency does not actually exist, but may desirable to determine a monetary value. In another embodiment, the monetary value is a synthetic monetary value. In such an embodiment, the synthetic monetary value may the value of other financial instruments, commodities futures contracts, etc.

However, the present invention is not limited to these embodiments and more, fewer and/or other pre-determined hedge fund data components with different valuations can be used to practice the invention.

At Step 54, the application 26 sorts the plural hedge funds to select a set of top performing hedge funds as described by one or more individual hedge fund index styles.

In one embodiment Step 54 includes sorting in descending order by dollar values of quarterly hedge fund AUM to determine a top AUM index; sorting in descending order dollar values of quarterly hedge fund assets inflows to determine a top total inflow index by calculating a difference in quarterly AUMs, A total inflow represents the net new inflow as total inflow minus outflow of AUM each quarter and previous quarter growth in an AUM of individual hedge funds; and calculating a top net new inflow index as a difference in a dollar value of quarterly hedge fund assets inflows minus outflows of AUMs each quarter and sorting in descending order of net new inflows each quarter (i.e., each quarter of a year or every three months). However, the present invention is not limited to the sorting step described and other sorting steps can be used to practice the invention.

At Step 58, the application 26 periodically rebalances with new pre-determined hedge fund data components as defined by an individual hedge fund index style. In one embodiment, the rebalancing is done quarterly (i.e., every quarter of a year, or every three months). However, the present invention is not limited a quarterly time period and other rebalancing time period can be used to practice the invention.

At Step 60, the application 26 calculates each individual hedge fund style index by taking an equally weighted average of hedge fund returns over a pre-determined time period of underlying top performing hedge funds for each individual hedge fund style index, thereby creating one or more sets of equal weighted tradable indices 38 representing hedge fund performance.

One specific exemplary embodiment for creating equal weighted tradable hedge fund indices is summarized in Table 2. However, the present invention is not limited to this embodiment, and more, fewer and/or other steps can be used to practice the invention.

TABLE 2

| | Select Universe of Hedge Funds with following data: |
|---|---|
| 1. | Hedge Fund name |
| 2. | Quarterly Assets under Management (AUM) ($ or other |
| | monetary value) |
| 3. | Quarterly Returns (%) |
| 4. | Quarterly Assets Inflows ($ or other monetary value) |
| 5. | Quarterly Asset outflows ($ or other monetary value) |

| | The selected hedge fund data is then sorted to select the top |
|---|---|
| | performing hedge funds as described by an individual index style |
| | under a category: |
| a. | Top AUM Index: The data is sorted (in descending order) of quarterly |
| | AUM |
| b. | Top Total Inflow Index: The Total Inflow is calculated as a difference |
| | in a quarterly AUM's. The total inflow represents the a new inflow |
| | (total inflow minus outflow of AUM each quarter) and previous |
| | quarter growth in AUM of individual top performing hedge funds. |
| | The data is sorted (in descending order) of total inflows each quarter. |
| c. | Top net new Inflow Index: Net new inflow is calculated as a |
| | difference in total inflow minus outflow of AUM each quarter. Once |
| | computed, the data is sorted (in descending order) of the net new |
| | inflows each quarter. |
| | a. A predefined count(N) of top individual hedge fund returns is |
| | selected as the components for the individual index styles. This |
| | selection is maintained through the quarter. |
| | b. The index is rebalanced with new components each quarter as |
| | defined by the individual index styles. |
| | Each style index is calculated by taking an equally weighted average |
| | of the quarterly returns of the underlying hedge funds for that style. |
| | For example, the TOP AUM style index under the equally weighted |
| | Index category comprises of an average quarterly return of the hedge |
| | funds with the TOP quarterly AUM. |
| | One or more sets of equal weighted tradable indices representing |
| | hedge fund performance are created. |

### Category 2: Asset Weighted Tradable Hedge Fund Indices

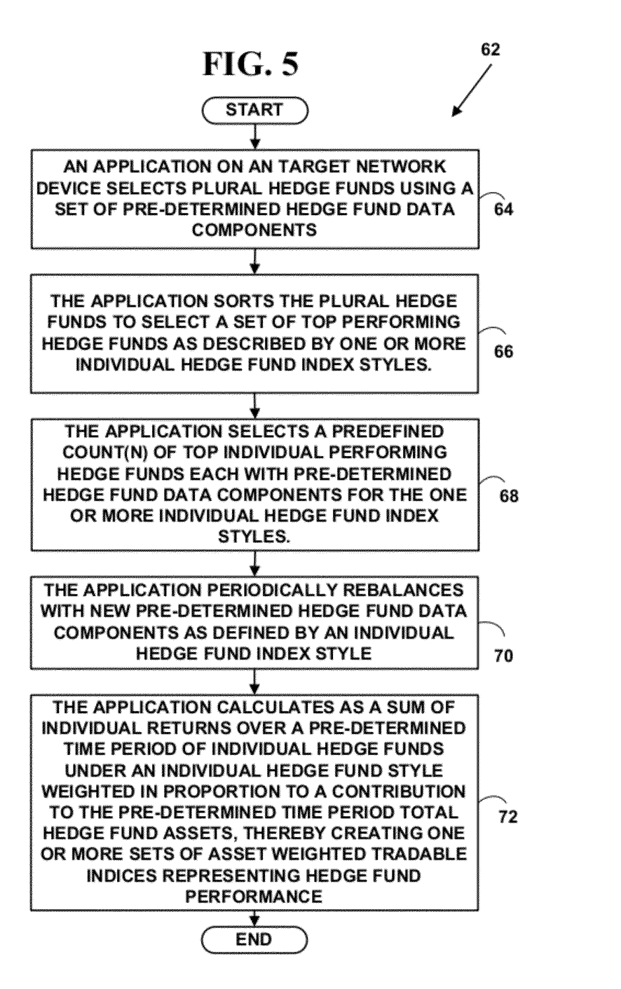

FIG. 5 is a flow diagram illustrating a Method 62 for creating asset weighted tradable hedge fund indices.

At Step 64, an application on a target network device selects plural hedge funds using a set of pre-determined hedge fund data components. At Step 66, the application sorts the plural hedge funds to select a set of top performing hedge funds as described by one or more individual hedge fund index styles. At Step 68, the application selects a predefined count(N) of top individual performing hedge funds with pre-determined hedge fund data components for the one or more top individual performing hedge fund index styles. At Step 70, the application periodically rebalances with new pre-determined hedge fund data components as defined by an individual hedge fund index style. At Step 72, the application calculates as a sum of individual hedge fund returns over a pre-determined time period of individual hedge funds under an individual hedge fund style weighted in proportion to a contribution to total hedge fund assets over the pre-determined time period, thereby creating one or more sets of asset weighted tradable indices representing hedge fund performance.

Method 62 is illustrated with a specific exemplary embodiment. However, the present invention is not limited to this specific exemplary embodiment and other embodiments can also be used to practice the invention.

In such an exemplary embodiment at Step 64, the application 26 on the target network device 12, 14, 16, selects plural hedge funds using a set of pre-determined hedge fund data components.

In one embodiment the set of pre-determined hedge fund data components includes: a hedge fund name, a dollar value of quarterly hedge fund assets under management (AUM), a percentage of quarterly hedge fund returns, a dollar value of quarterly hedge fund assets inflows and a dollar value of quarterly hedge fund asset outflows.

In another embodiment, the set of pre-determined hedge fund data components include: a hedge fund name, a monetary value of quarterly hedge fund assets under management (AUM), a percentage of quarterly hedge fund returns, a monetary value of quarterly hedge fund assets inflows and a monetary value of quarterly hedge fund asset outflows.

However, the present invention is not limited to this embodiment and more, fewer and/or other pre-determined hedge fund data components can be used to practice the invention.

At Step 66, the application 26 sorts the plural hedge funds to select a set of top performing hedge funds as described by one or more individual hedge fund index styles.

In one embodiment Step 68 includes: sorting in descending order dollar values of quarterly hedge fund AUM to determine a top AUM index; sorting in descending order dollar values of quarterly hedge fund assets inflows to determine a top total inflow index by calculating a difference in quarterly AUMs, a total inflow represents the net new inflow as total inflow minus outflow of AUM each quarter and previous quarter growth in an AUM of individual hedge funds; and calculating a top net new inflow index as a difference in a dollar value of quarterly hedge fund assets inflows minus outflows of AUMs each quarter and sorting in descending order of net new inflows each quarter (i.e., each quarter of a year or every three months). However, the present invention is not limited to the sorting step described and other sorting steps can be used to practice the invention.

At Step 70, the application 26 periodically rebalances with new pre-determined hedge fund data components as defined by an individual hedge fund index style. In one embodiment, the rebalancing is done quarterly periodically. However, the present invention is not limited a quarterly time period and other rebalancing time period can be used to practice the invention.

At Step 72, the application 26 calculates as a sum of individual hedge fun returns over a pre-determine time period of individual hedge funds under an individual hedge fund style weighted in proportion to a contribution to total hedge fund assets over the pre-determined time period, thereby creating one or more sets of asset weighted tradable indices 38 representing hedge fund performance.

In one exemplar embodiment, the pre-determined time period is a quarter of a year (i.e., three months). However, the present invention is not limited to this embodiment and other pre-determined time periods can be used to practice the invention.

One specific exemplary embodiment for creating asset weighted tradable hedge fund indices is summarized in Table 3. However, the present invention is not limited to this embodiment, and more, fewer and/or other steps can be used to practice the invention.

TABLE 3

Select Universe of Hedge Funds with following data:

1. Hedge Fund name
2. Quarterly Assets under Management (AUM) ($ or other
monetary value)
3. Quarterly Returns (%)
4. Quarterly Assets Inflows ($or other monetary value)
5. Quarterly Asset outflows ($or other monetary value)

The above data on hedge funds is then sorted to select top hedge
funds as described by a individual index style under the category:

| | |
|---|---|
| d. | Top AUM Index: The data is sorted (in descending order) of |
| | quarterly AUM. |
| e. | Top Total Inflow Index: The Total Inflow is calculated as a |
| | difference in the quarterly AUM's. The total inflow represents |
| | a net new inflow (total inflow minus outflow of AUM each |
| | quarter) and previous quarter growth in AUM of the individual |
| | hedge funds. The data is sorted (in descending order) of total |
| | inflows each quarter. |
| f. | Top net new Inflow Index: Net new inflow is calculated as a |
| | difference in total inflow minus outflow of AUM each quarter. |
| | Once computed, the data is sorted (in descending order) of a |
| | net new inflows each quarter. |

a. A predefined count(N) of top individual hedge fund returns is selected
as components for a individual index styles.
b. This selection is maintained through a quarter. An index is rebalanced
with new components each quarter as defined by the individual index
styles.
Each style index is calculated as the sum of individual quarterly returns of
individual hedge funds under that style weighted in proportion to their
contribution to the quarterly total assets.
One or more sets of asset weighted tradable indices representing hedge
fund performance are created.

### Category 3: Aggregated Hybrid Tradable Hedge Fund Indices

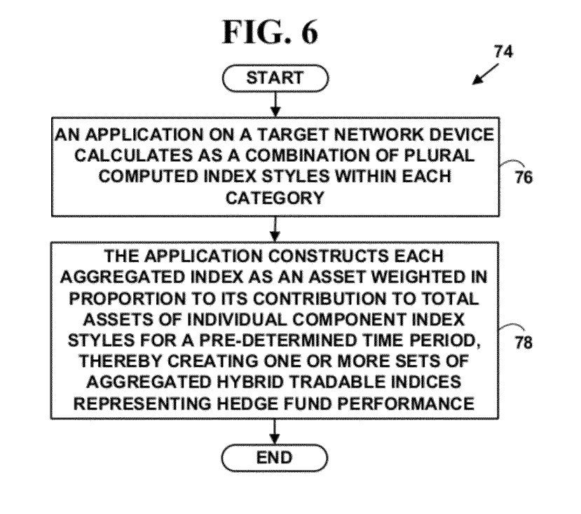

FIG. 6 is a flow diagram illustrating a Method 74 for creating aggregated hybrid tradable hedge fund indices. At Step 76, an application on a target network device calculates as a combination of plural computed index styles within a hedge fund index category. At Step 78, the application constructs each aggregated index as an asset weighted in proportion to its contribution to total assets of individual component index styles for a pre-determined time period, thereby creating one or more sets of aggregated hybrid tradable indices representing hedge fund performance.

Method 74 is illustrated with a specific exemplary embodiment. However, the present invention is not limited to this specific exemplary embodiment and other embodiments can also be used to practice the invention.

At Step 76, the application 26 on the target network device (e.g, 12, etc.) calculates as a combination of plural index styles within each hedge fund index category including equal weighted and/or equal weighted tradable indices.

At Step 78, the application 26 constructs each aggregated index as an asset weighted in proportion to its contribution to total assets of individual component index styles for a pre-determined time period (e.g., quarterly, etc.) thereby creating one or more sets of aggregated hybrid tradable indices 38 representing hedge fund performance.

In one embodiment, the one or more sets of aggregated hybrid tradable indices 38 representing hedge fund performance include, but are not limited to, Hybrid Index of Equally weighted indices comprising a combination of the equally weighted index category and/or Hybrid Index of AUM weighted indices comprising a combination of the AUM weighted index category. However, the present invention is not limited to this embodiment and more, fewer and/or other aggregated hybrid tradable indices representing hedge fund performance can be used to practice the invention.

In one specific exemplary embodiment, the aggregated hybrid indices are calculated as a combination of any two of the above computed index styles within each broad category (e.g., See Tables 1-3, etc.) and there are no cross category aggregated indices computed. In another embodiment, cross category aggregated indices are computed. In constructing each aggregated index, each index is asset weighted in proportion to its contribution to the total assets of the component index styles for that quarter. In another embodiment, the aggregated hybrid indices are calculated as a combination of any number of computed index styles. However, the present invention is not limited to this embodiment and other embodiments can be used to practice the invention.

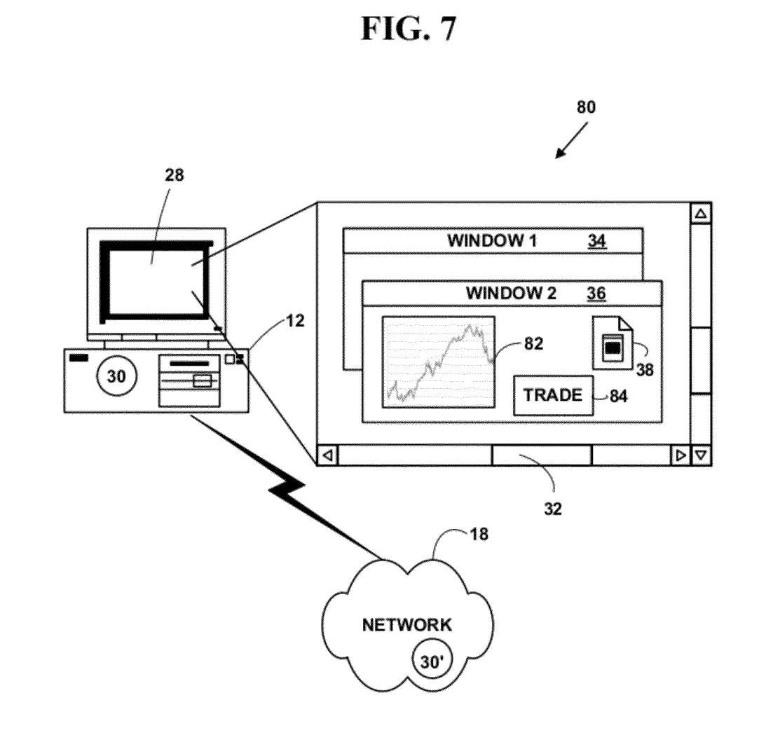

FIG. 7 is a block diagram 80 illustrating graphical display 82 of created tradable hedge fund indices 38 on the GUI 32. The GUI includes one or more graphical buttons 84 in one or more graphical windows for executing trades based on the created tradable hedge fund indices 38.

Only three broad categories of tradable hedge fund indices are described herein. However, the present invention is not limited to these three categories and/or more and/or fewer and/or categories and/or other types of created tradable hedge fund indices can be used to practice the invention.

The methods and system described herein include automatically creating a family of tradable hedge fund indices that seeks to match the performance of the hedge fund industry.

It should be understood that the architecture, programs, processes, methods and It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

We claim:

1. A method for creating tradable hedge fund indices, comprising:
obtaining one or more sets of hedge fund trading information on an application on a target device with one or more processors from one or more electronic trading exchanges including one or more server network devices each with one or more processors or one or more other server network devices each with one or more processors via a communications network;
creating automatically with the application one or more sets of tradable indices representing hedge fund performance from the received one or more sets of hedge fund trading information;
displaying with the application the created one or more sets of tradable hedge fund indices in one more windows on a multi-windowed graphical user interface (GUI); and
providing from the application secure execution of one or more electronic trades using the created one or more sets of tradable hedge fund indices displayed on the GUI on one or more electronic trading exchanges or hedge fund sites via the communications network.

2. One or more processors with a computer readable medium having stored therein a plurality of instructions for causing the one or more processors to execute the steps of the method of claim 1.

3. The method of claim 1 wherein the one or more sets of equal weighted tradable indices include equal weighted, asset weighted and aggregated hybrid, tradable hedge fund indices.

4. The method of claim 1 wherein the creating step further includes creating one or more sets of equal weighted tradable indices representing hedge fund performance comprising:
selecting from the application on the target network device a plurality of hedge funds using a set of pre-determined hedge fund data components;
sorting from the application the plurality of hedge funds to select a set of top performing hedge funds as described by one or more individual hedge fund index styles;
selecting from the application a predefined count(N) of top individual performing hedge funds with pre-determined hedge fund data components for the one or more individual hedge fund index styles;
rebalancing periodically from the application with new pre-determined hedge fund data components as defined by an individual hedge fund index style; and
calculating from the application each individual hedge fund style index by taking an equally weighted average of returns over a pre-determined time period of underlying hedge funds for each individual hedge fund style index, thereby creating one or more sets of equal weighted tradable indices representing hedge fund performance.

5. The Method of claim 4 wherein the pre-determined time period includes a quarter of a year and the set of pre-determined hedge fund data components includes: a hedge fund name, a dollar value or other monetary value of quarterly hedge fund assets under management (AUM), a percentage of quarterly hedge fund returns, a dollar value or other monetary value of quarterly hedge fund assets inflows and a dollar value or other monetary value of quarterly hedge fund asset outflows.

6. The Method of claim 4 wherein the sorting step includes:
sorting in descending order dollar values of quarterly hedge fund AUM to determine a top AUM index;
sorting in descending order dollar values of quarterly hedge fund assets inflows to determine a top total inflow index by calculating a difference in quarterly AUMs, wherein a total inflow represents the net new inflow as total inflow minus outflow of AUM each quarter and previous quarter growth in an AUM of individual hedge funds; and
calculating a top net new inflow index as a difference in a dollar value of quarterly hedge fund assets inflows minus outflows of AUMs each quarter and sorting in descending order of net new inflows each quarter.

7. The method of claim 1 wherein the creating step further includes creating one or more sets of asset weighted tradable indices representing hedge fund performance comprising:
selecting from the application on the target network device a plurality of hedge funds using a set of pre-determined hedge fund data components;
sorting from the application the plurality of hedge funds to select a set of top performing hedge funds as described by one or more individual hedge fund index styles;
selecting from the application a predefined count(N) of top individual performing hedge funds with pre-determined hedge fund data components for the one or more individual hedge fund index styles;
rebalancing periodically from the application with new pre-determined hedge fund data components as defined by an individual hedge fund index style; and
calculating from the application as a sum of individual returns over a pre-determined time period of individual hedge funds under an individual hedge fund style weighted in proportion to a contribution to total assets for the pre-determined time period, thereby creating one or more sets of asset weighted tradable indices representing hedge fund performance.

8. The Method of claim 7 wherein the pre-determined time period includes a quarter of a year and the set of pre-determined hedge fund data components includes: a hedge fund name, a dollar value or other monetary value of quarterly hedge fund assets under management (AUM), a percentage of quarterly hedge fund returns, a dollar value or other monetary of quarterly hedge fund assets inflows and a dollar value or other monetary value of quarterly hedge fund asset outflows.

9. The Method of claim 7 wherein the sorting step includes:
sorting in descending order dollar values of quarterly hedge fund AUM to determine a top AUM index;
sorting in descending order dollar values of quarterly hedge fund assets inflows to determine a top total inflow index by calculating a difference in quarterly AUMs, wherein a total inflow represents the net new inflow as total inflow minus outflow of AUM each quarter and previous quarter growth in an AUM of individual hedge funds; and
calculating a top net new inflow index as a difference in a dollar value of quarterly hedge fund assets inflows minus outflows of AUMs each quarter and sorting in descending order of net new inflows each quarter.

10. The method of claim 1 wherein the creating step further includes creating one or more sets of aggregated hybrid indices representing hedge fund performance comprising:
calculating from the application as a combination of a plurality of computed index styles within each category, including equal weighted or equal weighted tradable hedge fund indices; and
constructing from the application each aggregated index as an asset weighted index in proportion to its contribution to total assets of individual component index styles for the pre-determined time period, thereby creating one or more sets of aggregated hybrid tradable indices representing hedge fund performance.

11. The method of claim 1 wherein the target network device includes a wireless ultra-broadband Worldwide Interoperability for Microwave Access (WiMAX) wireless transceiver and communicates with a wireless communications network.

12. The method of claim 1 wherein the application includes a smart phone application and the target network device includes a smart phone.

13. The method of claim 1 wherein the application includes a tablet computer application and the target network device includes a tablet computer.

14. A system for creating tradable hedge fund indices, comprising in combination:
for obtaining one or more sets of hedge fund trading information on a application on a target device with one or more processors from one or more electronic trading exchanges including one or more server network devices each with one or more processors or one or more other server network devices each with one or more processors via a communications network;
for creating automatically with the application one or more sets of tradable indices representing hedge fund performance from the received one or more sets of hedge fund trading information, wherein the one or more sets of tradable indices include equal weighted, asset weighted and aggregated hybrid, tradable hedge fund indices;
for displaying with the application the created one or more sets of tradable hedge fund indices in one more windows on a multi-windowed graphical user interface (GUI); and
for providing from the application secure execution of one or more electronic trades using the created one or more sets of tradable hedge fund indices displayed on the GUI on one or more electronic trading exchanges via the communications network.

15. The system of claim 14 further comprising:
for creating one or more sets of equal weighted tradable indices representing hedge fund performance comprising:
for selecting from the application on the target network device a plurality of hedge funds using a set of pre-determined hedge fund data components;
for sorting from the application the plurality of hedge funds to select a set of top performing hedge funds as described by one or more individual hedge fund index styles;
for selecting from the application a predefined count(N) of top individual performing hedge funds with pre-determined hedge fund data components for the one or more individual hedge fund index styles;
for rebalancing periodically from the application with new pre-determined hedge fund data components as defined by an individual hedge fund index style; and
for calculating from the application each individual hedge fund style index by taking an equally weighted average of returns over a pre-determined time period of underlying hedge funds for each individual hedge fund style index, thereby creating one or more sets of equal weighted tradable indices representing hedge fund performance.

16. The system of claim 14 further comprising:
for creating one or more sets of asset weighted tradable indices representing hedge fund performance comprising:
for selecting from the application on the target network device a plurality of hedge funds using a set of pre-determined hedge fund data components;
for sorting from the application the plurality of hedge funds to select a set of top performing hedge funds as described by one or more individual hedge fund index styles;
for selecting from the application a predefined count(N) of top individual performing hedge funds with pre-determined hedge fund data components for the one or more individual hedge fund index styles;
for rebalancing periodically from the application with new pre-determined hedge fund data components as defined by an individual hedge fund index style; and
for calculating from the application as a sum of individual returns over the pre-determined time period of individual hedge funds under an individual hedge fund style weighted in proportion to a contribution to total assets over the pre-determined time period, thereby creating one or more sets of asset weighted tradable indices representing hedge fund performance.

17. The system of claim 14 further comprising:
for creating one or more sets of aggregated hybrid indices representing hedge fund performance comprising:
for calculating from the application as a combination a plurality of computed index styles within each category, including equal weighted or equal weighted tradable hedge fund indices; and
for constructing from the application each aggregated index as an asset weighted index in proportion to its contribution to total assets of individual component index styles for the pre-determined time period, thereby creating one or more sets of aggregated hybrid tradable indices representing hedge fund performance.

17. The system of claim 14 wherein the target network device includes a wireless ultra-broadband Worldwide Interoperability for Microwave Access (WiMAX) wireless transceiver and communicates with a wireless communications network.

18. The system of claim 14 wherein the application is a smart phone application and the target network device includes a smart phone.

19. The system of claim 14 wherein the application includes a tablet computer application and the target network device includes a tablet computer.
